(19) United States
(12) Patent Application Publication
(10) Pub. No.: US 2023/0387577 A1
(43) Pub. Date: Nov. 30, 2023

(54) ANTENNA STRUCTURE AND DISPLAY DEVICE INCLUDING THE SAME

(71) Applicant: DONGWOO FINE-CHEM CO., LTD., Jeollabuk-do (KR)

(72) Inventors: Won Hee LEE, Gyeonggi-do (KR); Dong Pil PARK, Incheon (KR)

(21) Appl. No.: 18/200,792

(22) Filed: May 23, 2023

(30) Foreign Application Priority Data
May 24, 2022 (KR) 10-2022-0063698

(51) Int. Cl. H01Q 1/36; H01Q 21/00; H01Q 3/00; H01Q 1/22

(52) U.S. Cl. CPC H01Q 1/36; H01Q 21/0087; H01Q 3/005; H01Q 1/22

(57) ABSTRACT

An antenna structure according to an embodiment includes a first radiation including a first radiator, a second radiation unit including a second radiator, and a third radiation unit including a third radiator. At least one of the first radiator, the second radiator and the third radiator includes a plurality of radiators coupled to each other in an array form. A first axis extending between a central point of the first radiator and a central point of the second radiator, and a second axis extending between the central point of the second radiator and a central point of the third radiator are perpendicular to each other.

### CROSS-REFERENCE TO RELATED APPLICATION AND CLAIM OF PRIORITY

This application claims priority to Korean Patent Application No. 10-2022-0063698 filed on May 24, 2022 in the Korean Intellectual Property Office (KIPO), the entire disclosures of which are incorporated by reference herein.

### BACKGROUND

### 1. Field

The present invention relates to an antenna structure and a display device including the same. More particularly, the present invention relates to an antenna structure including a plurality of radiators and a display device including the same.

### 2. Description of the Related Art

As information technologies have been developed, a wireless communication technology such as Wi-Fi, Bluetooth, etc., or a non-contact sensing such as a gesture detection and a motion recognition is being applied to or embedded in image display devices, electronic devices and architecture. For example, an antenna for performing communication in a high frequency or ultra-high frequency band is applied to various mobile devices.

For example, the wireless communication technology is combined with a display device in, e.g., a smartphone form. In this case, the antenna may be combined with the display device to provide a communication function.

As the display device to which the antenna is employed becomes thinner and lighter, a space for the antenna may also decrease. Accordingly, the antenna may be included in the form of a film or patch on a display panel so as to insert the antenna in a limited space.

However, when the antenna is disposed on the display panel, a coaxial circuit for transmitting and receiving signals or performing a feeding may not be easily constructed. Further, sensitivity may be lowered, or spatial efficiency and aesthetic property of a structure to which an antenna device is applied may be hindered due to an insertion of a coaxial power supply circuit.

For example, Korean Patent Publication No. 10-2014-0104968 discloses an antenna device including an antenna element and a ground element.

### SUMMARY

According to an aspect of the present invention, there is provided an antenna structure having improved signaling efficiency and radiation reliability.

According to an aspect of the present invention, there is provided a display device including the antenna structure.
(1) An antenna structure, including: a first radiation including a first radiator; a second radiation unit including a second radiator; and a third radiation unit including a third radiator, wherein at least one of the first radiator, the second radiator and the third radiator includes a plurality of radiators coupled to each other in an array form, and a first axis extending between a central point of the first radiator and a central point of the second radiator, and a second axis extending between the central point of the second radiator and a central point of the third radiator are perpendicular to each other.
(2) The antenna structure according to the above (1), wherein at least one of the first radiator, the second radiator and the third radiator includes 2ⁿ radiators arranged in an array form, and n is an integer from 1 to 4.
(3) The antenna structure according to the above (1), wherein each of the first radiator, the second radiator and the third radiator includes two or more radiators.
(4) The antenna structure according to the above (1), further including a dielectric layer on which the first radiation unit, the second radiation unit and the third radiation unit are disposed, wherein the first axis is inclined by a first tilt angle with respect to a width direction of the dielectric layer, and the second axis is inclined by a second tilt angle with respect to the width direction of the dielectric layer.
(5) The antenna structure according to the above (4), wherein the first tilt angle and the second tilt angle is each from 30° to 60°.
(6) The antenna structure according to the above (4), wherein the plurality of radiators included in the same radiation unit of the first radiation unit, the second radiation unit and the third radiation unit are arranged in the width direction of the dielectric layer, and a spacing distance between the plurality of radiators adjacent to each other in the width direction is equal to or greater than half a wavelength (λ/2) corresponding to a resonance frequency of the radiators.
(7) The antenna structure according to the above (1), wherein the first radiation unit further includes a first transmission line connected to the first radiator at the same layer as that of the first radiator, the second radiation unit further includes a second transmission line connected to the second radiator at the same layer as that of the second radiator, and the third radiation unit further includes a third transmission line connected to the third radiator at the same layer as that of the third radiator.
(8) The antenna structure according to the above (7), wherein the first radiation unit, the second radiation unit and the third radiation unit are disposed at the same layer.
(9) The antenna structure according to the above (7), wherein a transmission line connected to the plurality of radiators among the first transmission line, the second transmission line and the third transmission line includes a merge line coupling an adjacent pair of the radiators.
(10) The antenna structure according to the above (1), further including a fourth radiation unit spaced apart from the first radiation unit, the second radiation unit and the third radiation unit.
(11) The antenna structure according to the above (10), wherein the first radiation unit, the second radiation unit and the third radiation unit serve as reception radiation units, and the fourth radiation unit serves as a transmission radiation unit.
(12) The antenna structure according to the above (10), wherein the fourth radiation unit includes a plurality of radiators coupled to each other in an array form.
(13) The antenna structure according to the above (1), wherein the first radiator, the second radiator and the third radiator has a mesh structure.
(14) A motion recognition sensor including the antenna structure according to the above-described embodiments.
(15) A radar sensor including the antenna structure according to the above-described embodiments.
(16) A display device, including: a display panel; and the antenna structure according to the above-described embodiments disposed on the display panel.
(17) The display device according to the above (16), wherein the first axis is inclined by a first tilt angle with respect to a width direction of the display panel, and the second axis is inclined by a second tilt angle with respect to the width direction of the display panel.
(18) An antenna structure, including: a reception radiation unit which includes a first radiation unit including a first radiator, a second radiation unit including a second radiator; and a third radiation unit including a third radiator, and a transmission radiation unit including a plurality of fourth radiators coupled to each other, the transmission radiation unit physically spaced apart from the reception radiation unit, wherein a first axis extending between a central point of the first radiator and a central point of the second radiator, and a second axis extending between the central point of the second radiator and a central point of the third radiator are perpendicular to each other.
(19) The antenna structure according to the above (18), wherein the transmission radiation unit includes 2ⁿ fourth radiators arranged in an array form, and n is an integer from 1 to 4.
(20) The antenna structure according to the above (18), wherein each of the first radiation unit, the second radiation unit and the third radiation unit includes one radiator.

According to embodiments of the present invention, an antenna structure may include a first radiation unit, a second radiation unit, a third radiation unit and a fourth radiation unit which may be driven independently from each other. A first axis on which the first radiation unit and the second radiation unit are arranged and a second axis on which the third radiation unit and the second radiation unit are arranged may be perpendicular to each other. Accordingly, a strength and a change of a signal in two axes perpendicular to each other may be detected by the antenna structure.

In example embodiments, at least one of the first radiation unit, the second radiation unit, the third radiation unit and the fourth radiation unit may include two or more radiators. Accordingly, an intensity of the signal transmitted and received by the radiation units may be amplified, and a gain and a signal sensitivity of the antenna structure may be improved.

In some embodiments, a first direction and a second direction may be inclined at a predetermined tilting angle with respect to one side of the dielectric layer or one side of a display panel. Accordingly, signal imbalance of the radiators in the first axis and the second axis may be reduced, and performance of the antenna structure with respect to sensing motion, distance or gesture may be improved.

The antenna structure may be electrically coupled to a motion sensor circuit or a radar processor through a circuit board. Accordingly, signal information on a sensing target may be transmitted to the motion sensor circuit or radar processor, and a change in position, motion or distance of the sensing target may be measured based on the collected information.

### BRIEF DESCRIPTION OF THE DRAWINGS

FIG. 1 is a schematic plan view illustrating an antenna structure in accordance with exemplary embodiments.

FIGS. 2 and 3 are schematic plan views illustrating antenna structures in accordance with exemplary embodiments.

FIG. 4 is a schematic plan view illustrating an antenna structure in accordance with exemplary embodiments.

FIG. 5 is a schematic plan view illustrating an antenna structure in accordance with exemplary embodiments.

FIGS. 6 and 7 are a schematic plan view and a cross-sectional view illustrating a display device in accordance with exemplary embodiments.

### DETAILED DESCRIPTION OF THE EMBODIMENTS

According to exemplary embodiments of the present invention, an antenna structure including a plurality of radiation units capable of being driven independently is provided. According to exemplary embodiments of the present invention, a display device including the antenna structure is also provided. However, an application of the antenna structure is not limited to the display device, and the antenna structure may be applied to various objects or structures such as a vehicle, a home electronic appliance, an architecture, etc.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “one end”, “other end”, “upper side”, “lower side”, “upper side”, “lower side”, etc., as used herein are not intended to limit an absolute position or order, but is used in a relative sense to distinguish different components or elements.

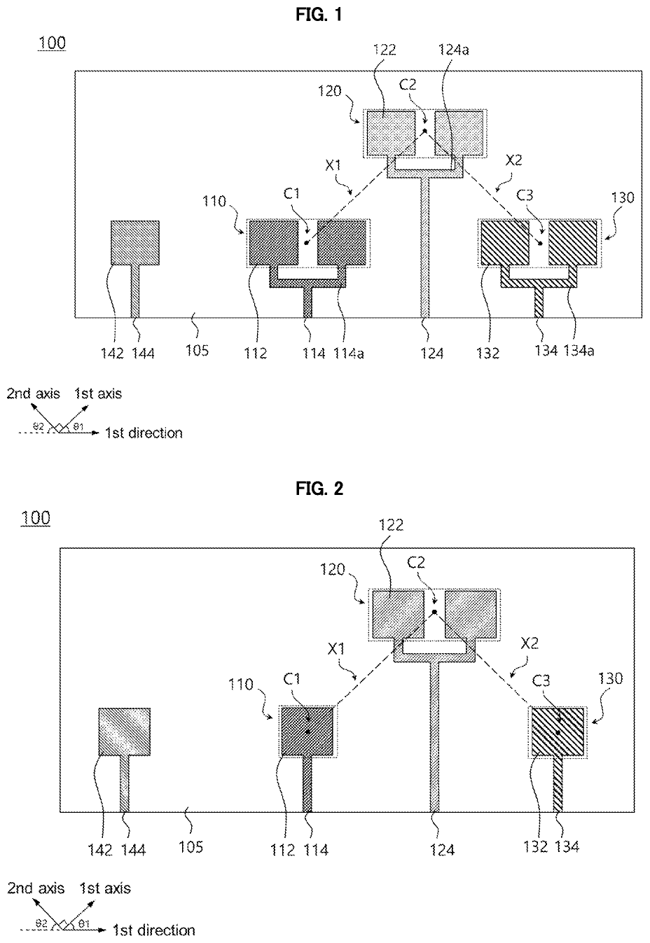

FIG. 1 is a schematic plan view illustrating an antenna structure in accordance with exemplary embodiments.

In FIG. 1, a first direction may correspond to a width direction of the antenna structure. The definition of the first direction may be equally applied to all accompanying drawings.

Referring to FIG. 1, the antenna structure 100 may include a dielectric layer 105, and a first radiation unit 110, a second radiation unit 120 and a third radiation unit 130 disposed on the dielectric layer 105.

The dielectric layer 105 may include, e.g., a transparent resin material. For example, the dielectric layer 105 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more thereof.

The dielectric layer 105 may include an adhesive material such as an optically clear adhesive (OCA), an optically clear resin (OCR), or the like. In some embodiments, the dielectric layer 105 may include an inorganic insulating material such as glass, silicon oxide, silicon nitride, silicon oxynitride, etc.

In an embodiment, the dielectric layer 105 may be provided as a substantially single layer.

In an embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

Capacitance or inductance for the antenna structure 100 may be formed by the dielectric layer 105, so that a frequency band at which the antenna structure may be driven or operated may be adjusted. In some embodiments, a dielectric constant of the dielectric layer 105 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer may be disposed on a bottom surface of the dielectric layer 105. Generation of an electric field in a transmission line may be more promoted by the ground layer, and an electrical noise around the transmission line may be absorbed or shielded.

In some embodiments, the ground layer may be included an individual member of the antenna structure 100. In some embodiments, a conductive member of an display device to which the antenna structure 100 is applied may serve as the ground layer 90. For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the display device such as a SUS plate, a sensor member such as a digitizer, a heat dissipation sheet, etc., may serve as the ground layer.

The first radiation unit 110 may include a first radiator 112. The second radiation unit 120 may include a second radiator 122. The third radiation unit 130 may include a third radiator 132.

At least one of the first radiation unit 110, the second radiation unit 120 and the third radiation unit 130 may include two or more radiators. For example, at least one of the first radiator 112, the second radiator 122 and the third radiator 132 may form an antenna array in which a plurality of radiators are arranged. A radiation unit may be defined by an antenna array formed of a plurality of the radiators.

The plurality of radiators 112, 122 and 132 may form the array and may be adjacent to each other, so that signal sensitivity of the radiation units 110, 120 and 130 may be improved, and an intensity of signal transmitted and received by the radiators may be amplified.

For example, when the antenna structure 100 is driven in a high frequency or ultra-high frequency band of 50 GHz or more, signal interference and loss may increase during transmission and reception of radio waves. Accordingly, gain and radiation concentration of the antenna structure may be reduced.

According to exemplary embodiments, the signal may be amplified by the radiators arranged in an array form, and radiation directivity of the radiation units 110, 120 and 130 may be improved. Thus, the antenna structure 100 may have high gain and sensitivity, and signal transmission/reception efficiency may be improved.

In an embodiment, a plurality of the radiators 112, 122 and 132 included in one radiation unit 110, 120 and 130 may be aligned in a width direction (e.g., the first direction) of the dielectric layer 105 to form a single row.

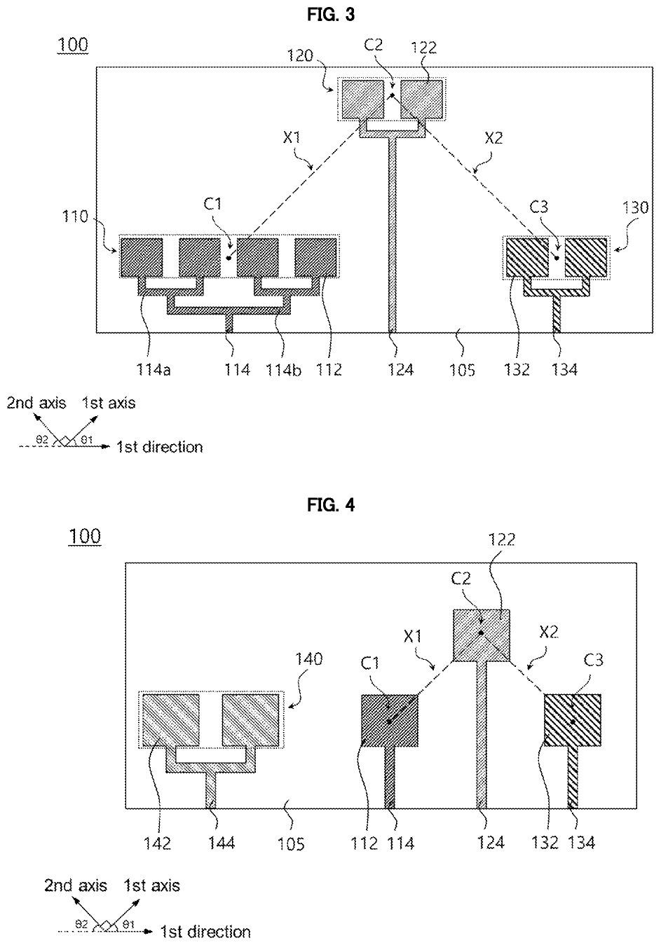

FIG. 2 is a schematic plan view illustrating an antenna structure in accordance with exemplary embodiments.

Referring to FIG. 2, one of the radiation units 110, 120 and 130 may include a plurality of radiators 122. FIG. 2 illustrates that the second radiation unit 120 includes a plurality of the second radiators 122, but the first radiation unit 110 may include a plurality of the first radiators 112. Alternatively, the third radiation unit 130 may include a plurality of the third radiators 132.

In an embodiment, at least two of the first radiation unit 110, the second radiation unit 120 and the third radiation unit 130 may include two or more radiators.

Referring to FIG. 1, all of the first radiation unit 110, the second radiation unit 120 and the third radiation unit 130 may include two or more radiators.

Accordingly, the signal strength from the first radiation unit 110, the second radiation unit 120 and the third radiation unit 130 may be amplified together. Additionally, a signal deviation between the radiation units 110, 120 and 130 may be lowered, thereby reducing a measurement error and increasing a resolution. Thus, performance and accuracy of sensing a motion, a distance and a gesture of a sensing target may be improved.

A central point C1 of the first radiator 112 and the central point C2 of the second radiator 122 may be arranged along a first axis X1. For example, the first axis X1 may be defined as an imaginary straight line extending between the central point C1 of the first radiator 112 and the central point C2 of the second radiator 122.

The central point C2 of the second radiator 122 and a central point C3 of the third radiator 132 may be arranged along a second axis X2. For example, the second axis X2 may be defined as an imaginary straight line extending between the central point C2 of the second radiator 122 and the central point C3 of the third radiator 132.

In an embodiment, when the radiation units 110, 120 and 130 include only one radiator, “the central point of the radiator” refers to a center of each radiator. In an embodiment, when the radiation units 110, 120, and 130 include a plurality of the radiators, the term “the central point of the radiator” refers to a center of a straight line or a polygon formed by centers of the radiators.

In example embodiments, the first axis X1 and the second axis X2 may be perpendicular to each other. For example, based on the central point C2 of the second radiator 122, the first axis X1 and the second axis X2 may cross each other to be perpendicular to each other.

Thus, the antenna structure 100 may detect a change of the signal strength in two axes X1 and X2 orthogonal to each other. For example, a motion sensor circuit or a radar processor may receive a signal information from the antenna structure 100, and, e.g., motions, positions and distances in all directions on an X-Y coordinate system may be measured based on the collected information.

In example embodiments, the antenna structure 100 may be provided as a motion sensor or a radar sensor capable of sensing motions in two axes perpendicular to each other.

The second radiation unit 120 may serve as a reference point for measuring signal changes in the first axis X1 and the second axis X2. For example, a change in a position of an object to be detected may be sensed by measuring a change of the signal intensity in the first axis X1 and the second axis X2 based on a signal intensity of the second radiation unit 120.

In some embodiments, each of the radiators 112, 122 and 132 may be designed to have a resonance frequency in a high or ultra-high frequency band of, e.g., 3G, 4G, 5G or higher. For example, the resonance frequency of each of the radiators 112, 122 and 132 may be about 50 GHz or higher, and may be, e.g., in a range of 50 GHz to 75 GHz, or from GHz to 65 GHz.

In example embodiments, the first radiation unit 110, the second radiation unit 120 and/or the third radiation unit 130 may include 2ⁿ radiators. The n may be an integer of 1 to 4.

FIG. 3 is a schematic plan view illustrating an antenna structure in accordance with example embodiments.

Referring to FIG. 3, the first radiation unit 110 may include four radiators 112 and the second radiation unit 120 and the third radiation unit 130 may each include two radiators 122 and 132.

Signal strength and radiation coverage may be adjusted by the number of the radiators included in the radiation units 110, 120 and 130. Thus, the number of the radiators included in each of the radiation units 110, 120 and 130 may be adjusted, so that a radiation directivity and a beam pattern of the antenna structure 100 may be appropriately implemented/changed according to driving environment and sensing conditions.

In an embodiment, a plurality of the radiators included in each of the radiation units 110, 120 and 130 may be arranged along a single row in the width direction (e.g., the first direction). In this case, a pair of the radiators 112, 122 and 132 adjacent to each other may be coupled to each other by a transmission line or a merging line.

In example embodiments, the antenna structure 100 may include transmission lines 114, 124 and 134 connected to the first radiation unit 110, the second radiation unit 120 and the third radiation unit 130, respectively. Thus, each of the first radiation unit 110, the second radiation unit 120 and the third radiation unit 130 may be driven independently, and electromagnetic signals in the first axis X1 and the second axis X2 may be detected independently from each other.

In some embodiments, the first transmission line 114, the second transmission line 124, and the third transmission line 134 may be disposed at the same layer or the same level as that of the first radiator 112, the second radiator 122 and the third radiator 132, respectively, on the dielectric layer 105.

The transmission lines 114, 124 and 134 may be disposed at the same level as that of the radiators 112, 122 and 132, so that feeding/driving may be implemented without a separate coaxial feeding for signal input/output and feeding. Thus, e.g., an antenna on display (AOD) in which the antenna structure 100 is disposed on a display panel may be implemented.

For example, the first transmission line 114 may be integral with the first radiator 112 and extend from one end of the first radiator 112.

For example, the second transmission line 124 may be integral with the second radiator 122 and extend from one end of the second radiator 122.

For example, the third transmission line 134 may be integral with the third radiator 132 and extend from one end of the third radiator 132.

The transmission lines 114, 124, and 134 may transmit a driving signal or a power from an antenna driving integrated circuit (IC) chip to the radiators 112, 122 and 132, and may transmit signals output from the radiators 112, 122, and 132 to the antenna driving IC chip or the motion sensor circuit.

In some embodiments, the transmission lines 114, 124 and 134 connected to the radiation unit including a plurality of radiators among the radiation units 110, 120 and 130 may include a merge line 114a, 124a and 134a. For example, when a plurality of the radiators included in one radiation unit 110, 120 and 130 are arranged in an array form, a pair of the radiators adjacent to each other may be coupled by the merge line.

For example, as illustrated in FIG. 1, two radiators 112, 122 and 132 adjacent to each other within one radiation unit 110, 120 and 130 may be coupled by the merge line 114a, 124a and 134a.

For example, as illustrated in FIG. 3, four radiators 112 in one radiation unit 110 may be coupled through merge lines 114a and 114b. In this case, the transmission line 114 may include a first merge line 114a coupling a pair of the radiators 112 adjacent to each other and a second merge line 114b coupling two pairs of the radiators 112 adjacent to each other.

Accordingly, a plurality of the radiators included in one radiation unit 110, 120 and 130 may be coupled to each other by the merge lines 114a, 124a and 134a, and one signal information may be measured or sensed through one radiation unit 110, 120 and 130.

In example embodiments, the first axis X1 and the second axis X2 may each be inclined at a predetermined tilt angle with respect to the width direction (e.g., the first direction) of the dielectric layer 105.

For example, the first axis X1 may be inclined by a first tilt angle θ1 with respect to the width direction of the dielectric layer 105, and the second axis X2 may be tilted by a second tilt angle θ2 with respect to the width direction of the dielectric layer 105.

Accordingly, a deviation of a length difference between the first transmission line 114 and the second transmission line 124 and the length difference between the second transmission line 124 and the third transmission line 134 may be reduced.

When the length difference between the first transmission line 114 and the second transmission line 124 and the length difference between the second transmission line 124 and the third transmission line 134 are different from each other, a signal sensitivity in the first axis (X1) and a signal sensitivity in the second axis (X2) may become different. In this case, motion detection performance may be degraded due to an increase in measurement errors of position/distance change in two axes.

In example embodiments, the first axis X1 and the second axis X2 may be inclined at a predetermined tilt angle with respect to the width direction of the dielectric layer 105, so that the transmission lines 114, 124 and 134 may be reduced to prevent signal loss and resistance increase.

Additionally, the length difference between the transmission lines 114, 124 and 134 may become small, so that a signal for the sensing target may be more uniformly and accurately measured.

In some embodiments, the first tilting angle θ1 and the second tilting angle θ2 may each be from 15° to 75°, or from 30° to 60°. Within the above range, the first radiation unit 110 and the third radiation unit 130 may be disposed symmetrically with respect to the second radiation unit 120. Accordingly, the deviation of the length difference between the first transmission line 114 and the second transmission line 124 and the length difference between the second transmission line 124 and the third transmission line 134 may be reduced.

More preferably, the first tilting angle θ1 and the second tilting angle θ2 may be 45°.

In some embodiments, the antenna structure 100 may further include a fourth radiation unit 140 disposed spaced apart from the first radiation unit 110, the second radiation unit 120 and the third radiation unit 130.

The fourth radiation unit 140 may include a fourth radiator 142 spaced apart from the first radiator 112, the second radiator 122 and the third radiator 132.

The fourth radiator 142 may serve as a transmission radiator for the motion sensing, and may emit an electromagnetic wave toward the sensing object. For example, the fourth radiation unit 140 may serve as a transmission radiation unit of the antenna structure 100.

The first radiator 112, the second radiator 122 and the third radiator 132 may serve as receiving radiators and may receive signals reflected from the sensing target. For example, the first radiation unit 110, the second radiation unit 120 and the third radiation unit 130 may serve as reception radiation units of the antenna structure 100.

Accordingly, the antenna structure 100 may receive and transmit wireless signals for the sensing object, and the motion sensor or the radar sensor may measure an attenuation or increase of the signal according to the position change and distance of the sensing object.

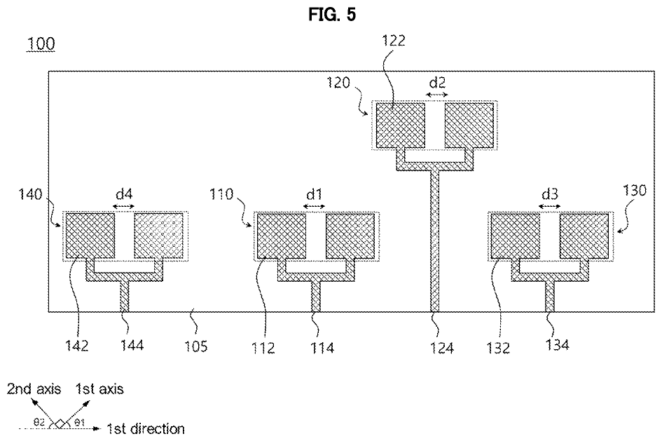

In one embodiment, the antenna structure 100 may include a fourth transmission line 144 electrically connected to the fourth radiator 142. The fourth transmission line 144 may be disposed at the same layer or at the same level as that of the fourth radiator 142. FIG. 4 is a schematic plan view illustrating an antenna structure in accordance with exemplary embodiments.

Referring to FIG. 4, the fourth radiation unit 140 may include a plurality of the radiators 142. For example, the fourth radiator 142 may have an array shape in which a plurality of the radiators 142 are arranged in the width direction (e.g., the first direction).

Accordingly. an intensity of an electromagnetic wave emitted from the fourth radiation unit 140 may be amplified. Thus, a sensing distance and a sensing performance may be improved, and the sensitivity of the antenna structure 100 for the sensing object may be improved.

In example embodiments, the fourth radiation unit 140 may include a plurality of the radiators 142, and the first radiation unit 110, the second radiation unit 120 and the third radiation unit 130 may each include a single radiator.

In example embodiments, the first radiation unit 110, the second radiation unit 120, the third radiation unit 130 and the fourth radiation unit 140 may all include a plurality of radiators.

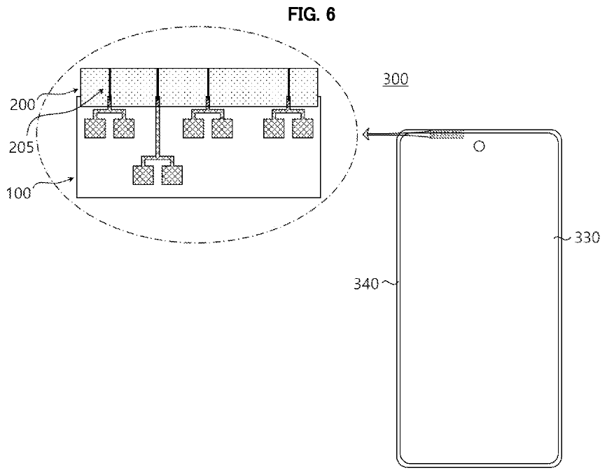

FIG. 5 is a schematic plan view illustrating an antenna structure in accordance with exemplary embodiments.

Referring to FIG. 5, each of the first radiator 112, the second radiator 122, the third radiator 132 and the fourth radiator 142 may include a plurality of radiators coupled to each other in an array form.

In this case, the intensity of the electromagnetic wave emitted from the fourth radiation unit 140 may be amplified. Further, sensitivity and signal reception efficiency of each of the first radiation unit 110, the second radiation unit 120 and the third radiation unit 130 may be improved. Accordingly, signal loss and distortion of the antenna structure 100 may be suppressed, and accuracy of motion recognition may be improved.

In some embodiments, a distances d1, d2, d3 and d4 between adjacent radiators among the plurality of the radiators included in one radiation unit 110, 120, 130 and 140 may be half a wavelength (λ/2) or more of a driving frequency of the corresponding radiator 112, 122, 132 and 142.

For example, the distance d1 between neighboring first radiators 112 in the width direction (e.g., the first direction) may be is half a wavelength (λ/2) or more of a wavelength corresponding to a resonance frequency of the first radiator 112.

For example, the distance d2 between the second radiators 122, the distance d3 between the third radiators 132 and the distance d4 between the fourth radiators 142 may each be half wavelength (λ/2) or more of a wavelength corresponding to a resonance frequency of the corresponding radiator.

In this case, the signal emitted from each of the radiation units 110, 120 and 130 may be amplified while suppressing signal interference between adjacent radiators. Thus, gain and radiation directivity of each of the radiation units 110, 120 and 130 may also be improved.

The radiators 112, 122, 132 and 142 and the transmission lines 114, 124, 134 and 144 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in a combination of at least two therefrom.

In an embodiment, the radiators 112, 122, 132 and 142 and the transmission lines 114, 124, 134 and 144 may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the radiators 112, 122, 132 and 142 and the transmission lines 114, 124, 134 and 144 may include a transparent conductive oxide such as indium tin oxide (ITO), indium zinc oxide (IZO), indium zinc tin oxide (ITZO), zinc oxide (ZnOx), etc.

In some embodiments, the radiators 112, 122, 132 and 142 and the transmission lines 114, 124, 134 and 144 may include a stacked structure of a transparent conductive oxide layer and a metal layer. For example, the antenna unit may include a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The radiators 112, 122, 132 and 142 and/or the transmission lines 114, 124, 134 and 144 may include a blackened portion, so that a reflectance at a surface of the radiators 112, 122, 132 and 142 and/or the transmission lines 114, 124, 134 and 144 may be decreased to suppress a visual pattern recognition due to a light reflectance.

In an embodiment, a surface of the metal layer included in the radiators 112, 122, 132 and 142 and the transmission lines 114, 124, 134 and 144 may be converted into a metal oxide or a metal sulfide to form a blackened layer. In an embodiment, a blackened layer such as a black material coating layer or a plating layer may be formed on the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

Referring to FIG. 5, each of the first radiator 112, the second radiator 122, the third radiator 132 and the fourth radiator 142 may have a mesh structure. Accordingly, transmittance of the antenna structure 100 may be improved.

In example embodiments, the radiators 112, 122, 132 and 142 and the transmission lines 114, 124, 134 and 144 may entirely include the mesh structure. In an embodiment, at least a portion of the transmission lines 114, 124, 134 and 144 may include a solid structure for a feeding efficiency.

For example, end portions of the transmission lines 114, 124, 134 and 144 may have a solid structure. In this case, the end portions of the transmission lines 114, 124, 134 and 144 may serve as signal pads.

In some embodiments, the antenna structure 100 may further includes a dummy mesh pattern (not illustrated) disposed around the first radiation unit 110, the second radiation unit 120, and the third radiation unit 130. For example, the dummy mesh pattern may be electrically and physically separated from the radiators 112, 122, and 132 and the transmission lines 114, 124 and 134 by a separation region.

For example, a conductive layer containing the metal or alloy as described above may be formed on the dielectric layer 105. A mesh structure may be formed while etching the conductive layer along profiles of the radiators 112, 122, 132 and 142 and transmission lines 114, 124, 134 and 144. Accordingly, the dummy mesh pattern spaced apart from the radiators 112, 122, 132 and 142 and the transmission lines 114, 124, 134 and 144 by the separation region may be formed.

Thus, transmittance of the antenna structure 100 may be improved. Further, the dummy mesh pattern may be distributed so that optical properties around the radiators 112, 122, 132 and 142 may become uniform. Therefore, the antenna structure 100 may be prevented from being visually recognized.

The antenna structure 100 may further include a signal pad. For example, the signal pad may be connected to each end portion of the transmission lines 114, 124, 134 and 144.

In an embodiment, the signal pad may be provided as a member substantially integral with the transmission lines 114, 124, 134 and 144. For example, the end portions of the transmission lines 114, 124, 134 and 144 may serve as the signal pads.

In some embodiments, a ground pad may be disposed around the signal pad. For example, a pair of the ground pads may face each other with the signal pad interposed therebetween. The ground pad may be electrically and physically separated from the transmission lines 114, 124, 134 and 144 and the signal pad.

In an embodiment, the signal pad and the ground pad may be formed as a solid metal pattern to reduce a feeding resistance through a circuit board and to prevent signal loss.

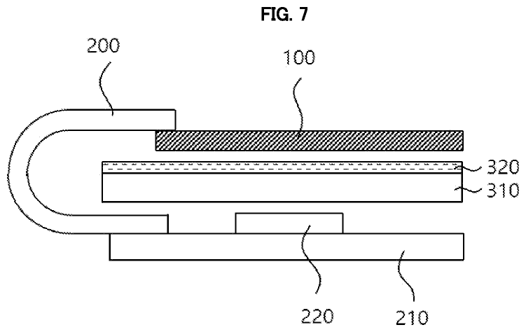

FIG. 6 is a schematic plan view illustrating a display device in accordance with example embodiments.

FIG. 6 illustrates a front portion or a window surface of the display device 300. The front portion of the display device 300 may include a display area 330 and a non-display area 340. The non-display area 340 may correspond to, e.g., a light-shielding portion or a bezel portion of an image display device.

The antenna structure 100 may be disposed toward the front portion of the display device 300, and may be disposed on, e.g., a display panel.

In some embodiments, the antenna structure 100 may be attached to the display panel in the form of a film.

In an embodiment, the antenna structure 100 may be formed throughout the display area 330 and the non-display area 340 of the display device 300. In one embodiment, the radiators 112, 122, 132 and 142 may at least partially overlie the display area 330.

In some embodiments, the antenna structure 100 may be located in a central portion of one side of the display device 300. Accordingly, deterioration of sensing performance at any side of the display device may be prevented, detection of motions, gestures or distances in all directions may be implemented on the front portion of the display device 300.

In some embodiments, one end of the transmission line 114, 124, 134 and 144 may be connected to the radiator 112, 122 and 132, and the other end of the transmission line 114, 124, 134 and 144 may be bonded to a circuit board 200.

The circuit board 200 may include, e.g., a flexible printed circuit boards (FPCB). For example, a conductive bonding structure such as an anisotropic conductive film (ACF) may be attached to the other ends of the transmission lines 114, 124, 134 and 144. The circuit board may be placed on the conductive bonding structure, and then heated and pressed.

The circuit board 200 may include a circuit wiring 205 bonded to the other end of the transmission line. The circuit wiring 205 may serve as an antenna feed wiring. For example, one end of the circuit wiring 205 may be exposed to an outside, and the exposed one end of the circuit wiring 205 may be bonded to the transmission lines 114, 124, 134 and 144. Thus, the circuit wiring 205 and the antenna structure 100 may be electrically connected.

An antenna driving IC chip may be mounted on the circuit board 200. In an embodiment, an intermediate circuit board such as a rigid printed circuit board may be disposed between the circuit board 200 and the antenna driving IC chip. In an embodiment, the antenna driving IC chip may be directly mounted on the circuit board 200.

A motion sensor driving circuit may be mounted on the circuit board 200. For example, the antenna structure 100 and the circuit board 200 may be electrically connected, so that signal information created from the antenna structure 100 may be transferred to the motion sensor driving circuit. Accordingly, a motion recognition sensor including the antenna structure 100 may be provided.

FIG. 7 is a schematic cross-sectional view illustrating a display device in accordance with example embodiments.

Referring to FIG. 7, the display device 300 may include a display panel 310 and the above-described antenna structure 100 disposed on the display panel 310.

In example embodiments, an optical layer 320 may be further included on the display panel 310. For example, the optical layer 320 may be a polarization layer including a polarizer or a polarizing plate.

In an embodiment, a cover window may be disposed on the antenna structure 100. The cover window may include, e.g., glass (e.g., ultra-thin glass (UTG)) or a transparent resin film. Accordingly, an external impact applied to the antenna structure 100 may be reduced or absorbed.

For example, the antenna structure 100 may be disposed between the optical layer 320 and the cover window. In this case, the dielectric layer 105 and the optical layer 320 disposed under the radiators 112, 122, 132 and 142 may commonly function as a dielectric layer of the radiators 112, 122, 132 and 142. Accordingly, an appropriate permittivity may be achieved so that the motion sensing performance of the antenna structure 100 may be sufficiently implemented.

For example, the optical layer 320 and the antenna structure 100 may be laminated through a first adhesive layer, and the antenna structure 100 and the cover window may be laminated through a second adhesive layer.

A flexible printed circuit board 200 may be bent along, e.g., a lateral side curved profile of the display panel 310 to be disposed at a rear portion of the display device 300 and extend toward an intermediate circuit board 210 (e.g., the main board) on which the driving IC chip is mounted.

The flexible printed circuit board 200 and the intermediate circuit board 210 may be bonded or connected to each other through a connector, so that feeding and antenna driving control to the antenna structure 100 by the antenna driving IC chip may be implemented.

In some embodiments, a motion sensor driving circuit 220 may be mounted on the intermediate circuit board 210. In an embodiment, the motion sensor driving circuit 220 may include a proximity sensor, a gesture sensor, an acceleration sensor, a gyroscope sensor, a position sensor, a geomagnetic sensor, etc.

In some embodiments, the first radiation unit 110, the second radiation unit 120 and the third radiation unit 130 may be coupled to the motion sensor driving circuit 220.

In an embodiment, the antenna structure 100 may be electrically connected to the motion sensor driving circuit 220 through the flexible circuit board 200 connected to the intermediate circuit board 210.

In an embodiment, the antenna structure 100 may measure the electromagnetic wave signal according to a movement of the sensing object, and the motion sensor driving circuit 220 coupled with the antenna structure 100 may detect a change of the signal corresponding to the movement of the sensing object to measure the motion.

For example, the second radiation unit 120 and the first radiation unit 110 may sense the movement of the sensing object along the first axis X1. The movement of the sensing target along the second axis X2 may be sensed by the second radiation unit 120 and the third radiation unit 130. Therefore, changes of the signals in two axes perpendicular to each other may be provided from the antenna structure 100 to the motion sensor driving circuit 220, and the motion sensor driving circuit 220 may measure a motion and a gesture along each axis.

In an embodiment, the motion sensor driving circuit 220 may include a motion detection circuit. Signal information transmitted from the antenna structure 100 may be converted/calculated into location information or distance information through the motion detection circuit.

In an embodiment, the antenna structure 100 may be electrically connected to a radar sensor circuit, and thus signal transmission/reception information may be transmitted to a radar processor. For example, the antenna structure 100 may be connected to the radar processor through the circuit board. Accordingly, a radar sensor including the antenna structure may be provided.

The radar sensor may analyze the transmission/reception signal to detect information about the sensing object. For example, the distance to the sensing object may be measured by radiating a radio wave from the antenna structure and receiving the radio wave reflected by the sensing object.

For example, the distance of the sensing object may be calculated by measuring a time required for the signal transmitted from the antenna structure to be reflected by the sensing object and received again by the antenna structure.

What is claimed is:

1. An antenna structure comprising:
a first radiation comprising a first radiator;
a second radiation unit comprising a second radiator; and
a third radiation unit comprising a third radiator,
wherein at least one of the first radiator, the second radiator and the third radiator comprises a plurality of radiators coupled to each other in an array form, and
a first axis extending between a central point of the first radiator and a central point of the second radiator, and a second axis extending between the central point of the second radiator and a central point of the third radiator are perpendicular to each other.

2. The antenna structure according to claim 1, wherein at least one of the first radiator, the second radiator and the third radiator comprises 2ⁿ radiators arranged in an array form, and n is an integer from 1 to 4.

3. The antenna structure according to claim 1, wherein each of the first radiator, the second radiator and the third radiator comprises two or more radiators.

4. The antenna structure according to claim 1, further comprising a dielectric layer on which the first radiation unit, the second radiation unit and the third radiation unit are disposed,
wherein the first axis is inclined by a first tilt angle with respect to a width direction of the dielectric layer, and the second axis is inclined by a second tilt angle with respect to the width direction of the dielectric layer.

5. The antenna structure according to claim 4, wherein the first tilt angle and the second tilt angle is each from 30° to 60°.

6. The antenna structure according to claim 4, wherein the plurality of radiators included in the same radiation unit of the first radiation unit, the second radiation unit and the third radiation unit are arranged in the width direction of the dielectric layer, and
a spacing distance between the plurality of radiators adjacent to each other in the width direction is equal to or greater than half a wavelength (λ/2) corresponding to a resonance frequency of the radiators.

7. The antenna structure according to claim 1, wherein the first radiation unit further comprises a first transmission line connected to the first radiator at the same layer as that of the first radiator, the second radiation unit further comprises a second transmission line connected to the second radiator at the same layer as that of the second radiator, and the third radiation unit further comprises a third transmission line connected to the third radiator at the same layer as that of the third radiator.

8. The antenna structure according to claim 7, wherein the first radiation unit, the second radiation unit and the third radiation unit are disposed at the same layer.

9. The antenna structure according to claim 7, wherein a transmission line connected to the plurality of radiators among the first transmission line, the second transmission line and the third transmission line comprises a merge line coupling an adjacent pair of the radiators.

10. The antenna structure according to claim 1, further comprising a fourth radiation unit spaced apart from the first radiation unit, the second radiation unit and the third radiation unit.

11. The antenna structure according to claim 10, wherein the first radiation unit, the second radiation unit and the third radiation unit serve as reception radiation units, and the fourth radiation unit serves as a transmission radiation unit.

12. The antenna structure according to claim 10, wherein the fourth radiation unit comprises a plurality of radiators coupled to each other in an array form.

13. The antenna structure according to claim 1, wherein the first radiator, the second radiator and the third radiator has a mesh structure.

14. A motion recognition sensor comprising the antenna structure according to claim 1.

15. A radar sensor comprising the antenna structure according to claim 1.

16. A display device comprising:
a display panel; and
the antenna structure according to claim 1 disposed on the display panel.

17. The display device according to claim 16, wherein the first axis is inclined by a first tilt angle with respect to a width direction of the display panel, and
the second axis is inclined by a second tilt angle with respect to the width direction of the display panel.

18. An antenna structure comprising:
a reception radiation unit which comprises:
a first radiation unit comprising a first radiator;
a second radiation unit comprising a second radiator; and
a third radiation unit comprising a third radiator, and
a transmission radiation unit comprising a plurality of fourth radiators coupled to each other, the transmission radiation unit physically spaced apart from the reception radiation unit,
wherein a first axis extending between a central point of the first radiator and a central point of the second radiator, and a second axis extending between the central point of the second radiator and a central point of the third radiator are perpendicular to each other.

19. The antenna structure according to claim 18, wherein the transmission radiation unit comprises 2ⁿ fourth radiators arranged in an array form, and n is an integer from 1 to 4.

20. The antenna structure according to claim 18, wherein each of the first radiation unit, the second radiation unit and the third radiation unit comprises one radiator.
